(19) United States
(12) Patent Application Publication
(10) Pub. No.: US 2026/0230184 A1
(43) Pub. Date: Aug. 6, 2026

(54) OPTICAL RELAY DEVICE, WAVELENGTH CONVERSION DEVICE, OPTICAL COMMUNICATION SYSTEM, AND OPTICAL RELAY METHOD

(71) Applicant: NEC Corporation, Tokyo (JP)

(72) Inventor: Toshifumi NAKAMURA, Tokyo (JP)

(73) Assignee: NEC Corporation, Tokyo (JP)

(21) Appl. No.: 19/154,396

(22) PCT Filed: Mar. 22, 2023
(86) PCT No.: PCT/JP2023/011243

§ 371 Date: Aug. 7, 2025

(51) Int. Cl. H04B 10/29; H04B 10/079; H04B 10/61

(52) U.S. Cl. CPC H04B 10/29; H04B 10/0795; H04B 10/0797; H04B 10/616

(57) ABSTRACT

Provided is an optical relay device comprising: a first reception unit that receives a first optical signal; a second reception unit that receives a second optical signal; a measurement unit that sequentially measures the quality of the first optical signal and the quality of the second optical signal; a first compensation unit that compensates for the first optical signal on the basis of the quality of the first optical signal measured by the measurement unit; a second compensation unit that compensates for the second optical signal on the basis of the quality of the second optical signal measured by the measurement unit; a first transmission unit that transmits the first optical signal which has been wavelength-converted; and a second transmission unit that transmits the second optical signal which has been wavelength-converted.

### TECHNICAL FIELD

The present disclosure relates to an optical relay device, a wavelength conversion device, an optical communication system, and an optical relay method.

### BACKGROUND ART

In a core network that supports large-capacity communication, technologies that meet the need for large capacities have been developed, such as Wavelength Division Multiplexing (WDM) in which optical signals of a plurality of different wavelengths are multiplexed into one optical fiber and transmitted, and advanced modulation systems such as Dual Polarization Differential Quadrature Phase Shift Keying (DP-QPSK) and 16 Quadrature Amplitude Modulation (16 QAM).

With the progress of 5G (5 th Generation) services in wireless communication, there is an increasing need for not only an increase in capacity but also a reduction in network delay.

In an optical communication system, since the same wavelength cannot be used in an optical fiber, optical signals arriving at an optical relay device (relay node) and having different paths at the same wavelength cannot be accommodated in the same optical fiber. Therefore, the optical relay device converts the wavelength of the optical signal in a certain path, and enables the optical signal in the path and the optical signal in another path to be accommodated in the same optical fiber.

PTL 1 discloses a technology for easily monitoring transmission quality of each optical signal of a wavelength multiplexed optical signal in a transmission line.

### PATENT LITERATURE

PTL 1: JP 2005-341161 A

### SUMMARY OF INVENTION

### Technical Problem

However, in the related art, for example, in a case where transmission is performed without performing signal processing such as error detection and correction (error detection and correction) as much as possible in order to reduce a delay involved in the relay, there is a possibility that an optical signal cannot be appropriately transmitted.

In view of the above-described problems, an object of the present disclosure is to provide a technology capable of more appropriately transmitting an optical signal in an optical communication system for converting a wavelength of an optical signal by an optical relay device in a path.

### Solution to Problem

In a first aspect according to the present disclosure, there is provided an optical relay device including a first reception unit for receiving a first optical signal, a second reception unit for receiving a second optical signal, a measurement unit for sequentially measuring a quality of the first optical signal and a quality of the second optical signal, a first compensation unit for compensating for the first optical signal based on the quality of the first optical signal measured by the measurement unit, a second compensation unit for compensating for the second optical signal based on the quality of the second optical signal measured by the measurement unit, a first transmission unit for transmitting the first optical signal subjected to wavelength conversion, and a second transmission unit for transmitting the second optical signal subjected to wavelength conversion.

Furthermore, in a second aspect according to the present disclosure, there is provided an optical communication system including an optical relay device and a management device, in which the optical relay device includes: a first reception unit for receiving a first optical signal, a second reception unit for receiving a second optical signal, a measurement unit for sequentially measuring a quality of the first optical signal and a quality of the second optical signal, a first compensation unit for compensating for the first optical signal based on the quality of the first optical signal measured by the measurement unit, a second compensation unit for compensating for the second optical signal based on the quality of the second optical signal measured by the measurement unit, a first transmission unit for transmitting the first optical signal subjected to wavelength conversion, and a second transmission unit for transmitting the second optical signal subjected to wavelength conversion, and the management device switches a reception unit for receiving the first optical signal from the first reception unit to the second reception unit based on the quality of the first optical signal measured by the measurement unit.

Furthermore, in a third aspect according to the present disclosure, there is provided a wavelength conversion device including a first reception unit for receiving a first optical signal, a second reception unit for receiving a second optical signal, a measurement unit for sequentially measuring a quality of the first optical signal and a quality of the second optical signal, a first compensation unit for compensating for the first optical signal based on the quality of the first optical signal measured by the measurement unit, a second compensation unit for compensating for the second optical signal based on the quality of the second optical signal measured by the measurement unit, a first transmission unit for transmitting the first optical signal subjected to wavelength conversion, and a second transmission unit for transmitting the second optical signal subjected to wavelength conversion.

Furthermore, in a fourth aspect of the present disclosure, there is provided an optical relay method including: receiving a first optical signal by a first reception unit, receiving a second optical signal by a second reception unit, sequentially measuring a quality of the first optical signal and a quality of the second optical signal, compensating for the first optical signal based on the measured quality of the first optical signal, and transmitting the first optical signal subjected to wavelength conversion; and compensating for the second optical signal based on the measured quality of the second optical signal, and transmitting the second optical signal subjected to wavelength conversion.

### Advantageous Effects of Invention

According to one aspect, an optical signal can be more appropriately transmitted in an optical communication system for converting a wavelength of an optical signal by an optical relay device in a path.

### BRIEF DESCRIPTION OF DRAWINGS

FIG. 1 is a diagram illustrating an example of a configuration of an optical relay device according to an example embodiment.

FIG. 2 is a diagram illustrating an example of a configuration of an optical communication system according to the example embodiment.

FIG. 3 is a diagram illustrating an example of processing of the optical relay device according to the example embodiment.

FIG. 4 is a diagram illustrating an example of information recorded in a measurement result table according to the example embodiment.

FIG. 5 is a diagram illustrating an example of a more detailed configuration of the optical relay device according to the example embodiment.

FIG. 6 is a diagram illustrating an example of a configuration of a wavelength conversion device according to the example embodiment.

FIG. 7 is a diagram illustrating an example of a configuration of a coherent reception front end (FE) according to the example embodiment.

FIG. 8 is a diagram illustrating an example of a configuration of the coherent transmission front end according to the example embodiment.

FIG. 9 is a diagram illustrating an example of a configuration of a wavelength conversion device according to the example embodiment.

FIG. 10 is a diagram illustrating an example of a configuration of the wavelength conversion device according to the example embodiment.

FIG. 11 is a diagram illustrating an example of a configuration of the wavelength conversion device according to the example embodiment.

FIG. 12 is a diagram illustrating a hardware configuration example of a computer of a determination unit (control unit) according to the example embodiment.

### EXAMPLE EMBODIMENTS

The principles of the present disclosure will be described with reference to several example embodiments. It is to be understood that the example embodiments have been described for purposes of illustration only and will aid those skilled in the art in understanding and carrying out the present disclosure without suggesting limitations on the scope of the present disclosure. The disclosure described in the present description is implemented in various methods other than those described below.

In the following description and claims, unless defined otherwise, all technical and scientific terms used in the present specification have the same meaning as commonly understood by those skilled in the art of the technical field to which the present disclosure belongs.

Hereinafter, example embodiments of the present disclosure will be described with reference to the drawings.

### First Example Embodiment

### Configuration of Optical Relay Device 10

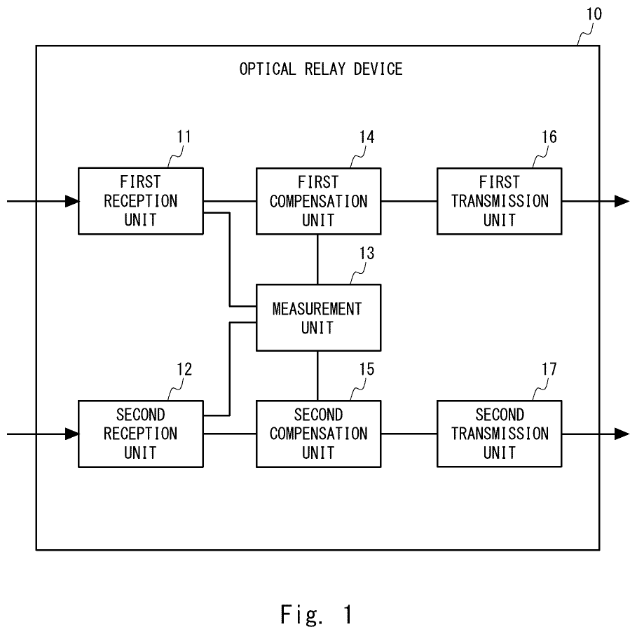

A configuration of an optical relay device 10 according to an example embodiment will be described with reference to FIG. 1. FIG. 1 is a diagram illustrating an example of a configuration of an optical relay device 10 according to an example embodiment. In the example of FIG. 1, the optical relay device 10 includes a first reception unit 11, a second reception unit 12, a measurement unit 13, a first compensation unit 14, a second compensation unit 15, a first transmission unit 16, and a second transmission unit 17. The number of sets of the reception unit, the compensation unit, and the transmission unit merely needs to be two or more, and is not limited to the example of FIG. 1. In the present disclosure, light of an optical signal, an analog electric signal obtained by converting the optical signal, and digital data obtained by converting the optical signal may be simply referred to as an “optical signal”.

The first reception unit 11 is a port for receiving a first optical signal. The second reception unit 12 is a port for receiving a second optical signal. The first optical signal and the second optical signal may be optical signals having different transmission source nodes (optical relay device, terminal, etc.) or may be optical signals having different destination (transmission destination) nodes.

The measurement unit 13 sequentially measures the quality of the first optical signal and the quality of the second optical signal. The first compensation unit 14 compensates the first optical signal based on the quality of the first optical signal measured by the measurement unit 13. The second compensation unit 15 compensates the second optical signal based on the quality of the second optical signal measured by the measurement unit 13.

The first transmission unit 16 is a port for transmitting the wavelength-converted first optical signal. The first transmission unit 16 may transmit the first optical signal having a wavelength different from the wavelength of the first optical signal received by the first reception unit 11 to the destination node.

The second transmission unit 17 is a port for transmitting the wavelength-converted second optical signal. The second transmission unit 17 may transmit the second optical signal having a wavelength different from the wavelength of the second optical signal received by the second reception unit 12 to the destination node.

### Second Example Embodiment

### System Configuration

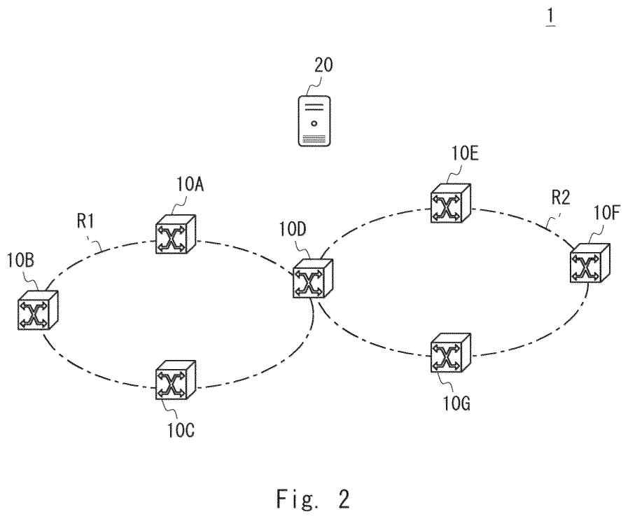

Next, a configuration of an optical communication system 1 according to the example embodiment will be described with reference to FIG. 2. The optical communication system 1 may be, for example, an all-photonics network using Optical to Analog to Optical (O-A-O) wavelength conversion for converting a wavelength of an optical signal by analog signal processing without performing digital signal processing. Furthermore, the optical communication system 1 may include, for example, an optical relay device for converting an optical signal of a certain wavelength into a digital signal and re-converting the digital signal into an optical signal of a different wavelength without performing digital signal processing such as error detection and correction.

FIG. 2 is a diagram illustrating an example of a configuration of the optical communication system 1 according to the example embodiment. In the example of FIG. 2, the optical communication system 1 includes optical relay devices 10A to 10G (hereinafter also referred to simply as “optical relay device 10” in a case where there is no need to distinguish) and a management device 20. The management device 20 may be referred to as, for example, a Network Management System (NMS), a network manager, or the like. The numbers of the optical relay devices 10 and the management devices 20 are not limited to the example of FIG. 2.

In the example of FIG. 2, the optical relay devices 10A to 10D form a ring network R1. Furthermore, the optical relay devices 10D to 10G form a ring network R2. The optical relay device 10D connects the ring network R1 and the ring network R2. The optical relay device 10 may have a function of converting an electric signal of data transmitted from a terminal into an optical signal and transmitting and transferring the optical signal. In addition, the optical relay device 10 may have a function of converting a received optical signal into an electric signal and transferring the electric signal to the terminal.

The management device 20 is connected to one or more optical relay devices 10 via a signal line (e.g., an optical fiber or a Local Area Network (LAN) cable). Each optical relay device 10 is connected to two or more other optical relay devices 10 via an optical transmission line (e.g., an optical fiber). A connection form (network topology) between the management device 20 and each optical relay device 10 may be, for example, a mesh shape, a ring shape, or the like.

### Processing

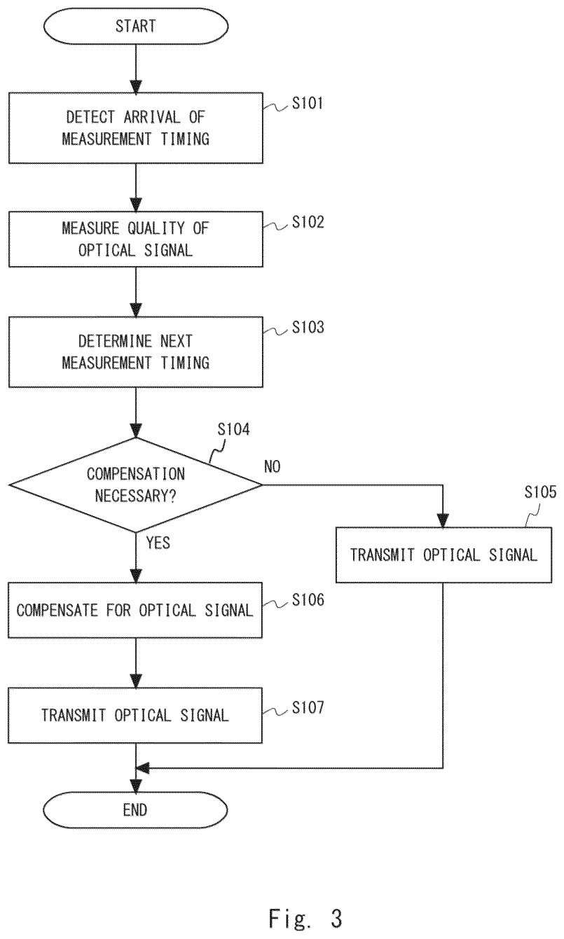

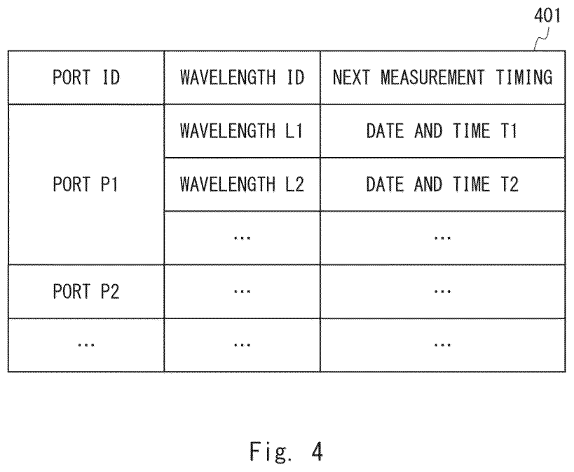

Next, an example of processing of the optical relay device 10 according to the example embodiment will be described with reference to FIGS. 3 to 4. FIG. 3 is a flowchart illustrating an example of the processing of the optical relay device 10 according to the example embodiment. The following processing may be executed, for example, in a case where the first optical signal is received by the first reception unit 11 and the first optical signal is transmitted (relayed, transferred) by the first transmission unit 16. Hereinafter, processing for a first set of the first reception unit 11, the first compensation unit 14, and the first transmission unit 16 will be described, but similar processing is executed for a second set of the second reception unit 12, the second compensation unit 15, and the second transmission unit 17. Since the measurement unit 13 is shared by the first set and the second set, the measurement unit 13 may sequentially (intermittently at different timings) execute the processing for the first set and the processing for the second set.

In step S101, the measurement unit 13 refers to a measurement result table 401 and detects that the timing for measuring the quality of the first optical signal received by the first reception unit 11 has arrived. In the example of FIG. 4, the communication start date and time, the quality, the compensation parameter, and the next measurement timing are recorded in the measurement result table 401 in association with the combination of a port ID and a wavelength ID. The port ID is identification information of a physical port to which each optical fiber is connected in the optical relay device 10. The wavelength ID is identification information of a wavelength (band) of an optical signal. The communication start date and time is a date and time at which communication by an optical signal is started. The quality is the quality of the optical signal. The quality may be, for example, a Q-value or the like. The compensation parameter is a parameter for compensating an optical signal calculated based on a parameter during the measurement unit 13 performs error detection for measuring the quality of the optical signal. The communication start date and time may be recorded by the measurement unit 13, for example, at which communication by an optical signal is started.

The next measurement timing is information indicating a timing at which the quality of the optical signal is to be measured next time. In the example of FIG. 4, it is recorded that the optical signal having the wavelength L1 received at the port P1 is measured at the date and time T1.

Subsequently, the measurement unit 13 measures the quality of the first optical signal received by the first reception unit 11 (step S102). Here, for example, the measurement unit 13 may calculate (measure) the quality of the first optical signal based on an error rate (e.g., Bit Error Rate (BER) or a Q-value) of the first optical signal based on an Error Correction Code (ECC) of data based on the first optical signal received by the first reception unit 11. In this case, the quality is higher (better) the lower the error rate. The error correction code may be, for example, a code added in such a way that an error generated in data transmission can be corrected on the reception side. The error correction code may be added in advance at the time of data transmission by, for example, Forward Error Correction (FEC). For example, the measurement unit 13 may calculate the quality based on the error correction code by using digital data subjected to processing such as frequency compensation, polarization separation, and symbol mapping after analog-digital (A/D) conversion of the first optical signal.

Subsequently, the measurement unit 13 determines a timing or the like to measure the quality of the first optical signal next time and records the determined timing or the like in the measurement result table 401 (step S103).

Here, for example, the measurement unit 13 may record the quality, the compensation parameter, the next measurement timing, and the like in association with a set of the port ID and the wavelength ID related to the first optical signal.

### Example of Determining Measurement Frequency Based on Quality of Optical Signal

The measurement unit 13 may determine the frequency of measuring the quality of the optical signal based on the quality of the measured optical signal. In this case, for example, if the quality of the measured optical signal is the first quality, the measurement unit 13 may measure the quality of the optical signal at a first frequency, and if the quality of the measured optical signal is the second quality lower than the first quality, the measurement unit may measure the quality of the optical signal at a second frequency higher than the first frequency. As a result, the measurement is performed more frequently the lower the quality of the optical signal. Therefore, an optical signal having lower quality can be compensated at a higher frequency.

### Example of Determining Measurement Frequency Based on Elapsed Time of Communication by Optical Signal

The measurement unit 13 may determine the frequency of measuring the quality of the optical signal based on the elapsed time of communication by the optical signal. In this case, for example, if the elapsed time of communication by the optical signal is a first elapsed time, the measurement unit 13 may measure the quality of the optical signal at a third frequency and if the elapsed time of communication by the optical signal is a second elapsed time longer than the first elapsed time, the measurement unit 13 may measure the quality of the optical signal at a fourth frequency lower than the third frequency. As a result, the measurement is performed more frequently the shorter the elapsed time of communication by the optical signal. Therefore, for example, an optical signal in which the operation of the other optical relay device 10 is relatively unstable shortly after the connection of the communication can be compensated more frequently, for example, the measurement unit 13 may calculate an elapsed time from the communication start date and time recorded in the measurement result table 401 to the current date and time as an elapsed time of communication by an optical signal.

Subsequently, the measurement unit 13 determines whether compensation for the first optical signal is necessary based on the measured quality (step S104). Here, for example, in a case where the measured quality is less than a threshold value, the measurement unit 13 may determine that compensation for the optical signal is necessary. In addition, for example, the measurement unit 13 may determine the degree of necessary compensation to be higher the lower the measured quality.

If it is determined that the compensation for the first optical signal is not necessary (NO in step S104), the first transmission unit 16 transmits the first optical signal received by the first reception unit 11 without compensation (step S105), and ends the processing. Here, the first transmission unit 16 may wavelength-convert the first optical signal received by the first reception unit 11 and transmit the same.

On the other hand, if it is determined that the compensation for the first optical signal is necessary (YES in step S103), the first compensation unit 14 compensates for the first optical signal based on the measurement result of the quality of the first optical signal measured by the measurement unit 13 (step S106). Here, for example, the first compensation unit 14 may execute compensation to a higher degree the lower the measured quality. Each compensation processing may be a compensation processing in which the power consumption and the processing delay increase as the processing content is more complex the higher the degree of compensation.

Subsequently, the first transmission unit 16 wavelength-converts the first optical signal compensated by the first compensation unit 14 and transmits the same (step S107), and ends the processing. Here, the first transmission unit 16 transmits the first optical signal by a second wavelength different from the first wavelength of the first optical signal received by the first reception unit 11.

### Configuration of Optical Relay Device 10

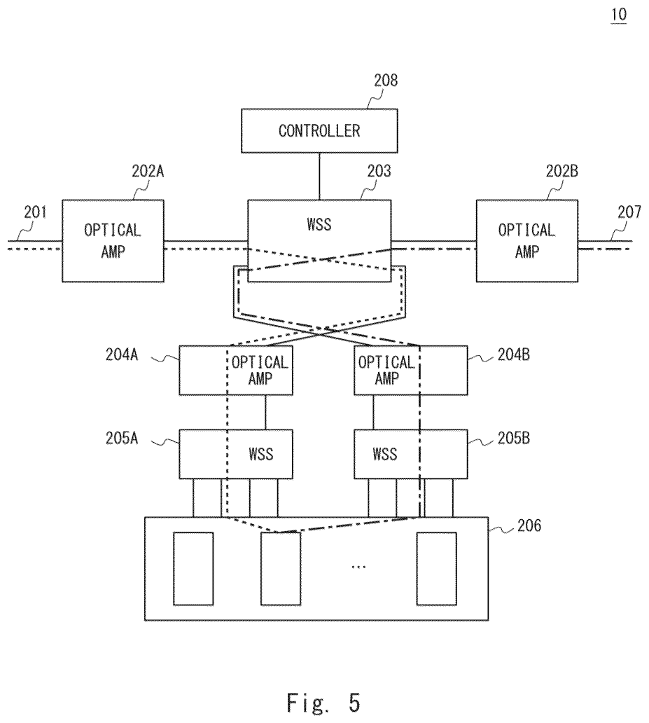

Next, a more detailed configuration of the optical relay device 10 according to the example embodiment will be described with reference to FIG. 5. FIG. 5 is a diagram illustrating an example of a more detailed configuration of the optical relay device 10 according to the example embodiment. In the example of FIG. 5, the optical relay device 10 includes one or more optical fibers 201, an optical amplifier (optical amplifier, optical AMP) 202A, an optical amplifier 202B, an optical switch (WSS, Wavelength Selective Switch) 203, an optical amplifier 204A, an optical amplifier 204B, an optical switch 205A, an optical switch 205B, one or more wavelength conversion devices 206, one or more optical fibers 207, and a controller 208.

In the optical amplifier 202, the optical relay device 10 compensates for the transmission loss of the optical signal input from the optical fiber 201 in units of fibers. The optical switch 203 switches the optical signal from the optical amplifier 202 in units of wavelengths, and for example, outputs the same to the amplifier 204A.

The optical amplifier 204 compensates for the loss of the optical signal from the wavelength conversion port of the optical switch 203 and outputs the same to the optical switch 205A. The optical switch 205A separates the optical signal in units of fibers from the optical amplifier 204A into units of wavelengths and outputs the same to the wavelength conversion device 206.

The wavelength conversion device 206 converts the optical signal having the first wavelength from the optical switch 205A into an electric signal, performs analog signal processing such as analog compensation on the electric signal, converts the electric signal into an optical signal having the second wavelength, and outputs it to the optical switch 205B. The wavelength conversion device 206 temporarily converts the optical signal into an electric signal, but performs only the analog signal processing, converts it again into an optical signal having a different wavelength, and relays the optical signal. Although an analog delay of the electric circuit occurs physically, the delay is equal to or less than several nsec. at the maximum and is negligibly small. Therefore, as compared with a case where wavelength conversion is performed by digital signal processing, a wavelength conversion function having a low latency can be achieved in units of channels.

Here, the wavelength conversion device 206 may perform, for example, band compensation, PDL compensation (polarization dependency loss compensation), dispersion compensation, and the like as analog compensation. Since the same wavelength cannot be used in the optical fiber, optical signals arriving at the optical relay device 10 and having different paths at the same wavelength cannot be accommodated in the same optical fiber. Therefore, the optical relay device 10 converts the wavelength of the optical signal in a certain path from the first wavelength to the second wavelength using the wavelength conversion device 206, and enables the optical signal in the path converted to the second wavelength and the optical signal having the first wavelength in another path to be accommodated in the same optical fiber.

The optical switch 205B bundles the optical signals in units of wavelengths from the wavelength conversion device 206 in units of fibers and outputs the same to the optical amplifier 204B.

The optical amplifier 204B compensates for the loss of the optical signal from the optical switch 205B and outputs the optical signal to the optical switch 203. The optical switch 203 receives an optical signal in units of fibers from the optical amplifier 204B, performs switching in units of wavelengths, and outputs to the optical amplifier 202B. The optical amplifier 202B compensates for the transmission loss of the optical signal from the optical switch 203 in units of fibers, and outputs the same to the optical fiber 207. The optical fiber 207 outputs the optical signal in units of fibers from the optical amplifier 202B to the other optical relay device 10. The controller 208 controls each device (e.g., optical switch 203) in the optical relay device 10.

### Configuration of Wavelength Conversion Device 206

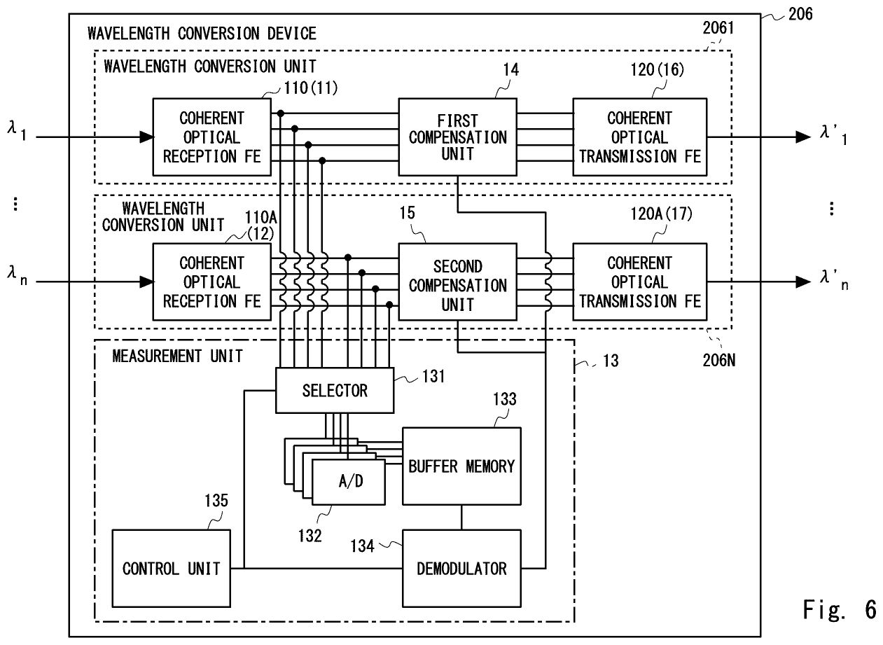

Next, a configuration of the wavelength conversion device 206 according to the example embodiment will be described with reference to FIG. 6. FIG. 6 is a diagram illustrating an example of a configuration of the wavelength conversion device 206 according to the example embodiment.

In the example of FIG. 6, the wavelength conversion device 206 includes wavelength conversion units 2061 to 206N (N is an integer equal to or more than two) and a measurement unit 13. Hereinafter, the wavelength conversion unit 2061 will be mainly described as an example, but the wavelength conversion units 2062 to 206N may also have the same configuration as the wavelength conversion unit 2061. Therefore, the second compensation unit 15 may have a configuration similar to that of the first compensation unit 14. The following processing and configurations can be appropriately combined and used.

The wavelength conversion unit 2061 includes a coherent reception front end 110, a first compensation unit 14, and a coherent transmission front end 120. The wavelength conversion unit 206N includes a coherent reception front end 110A, a second compensation unit 15, and a coherent transmission front end 120A.

The coherent reception front end 110 is an example of the first reception unit 11. The coherent transmission front end 120 is an example of the first transmission unit 16. The coherent reception front end 110A is an example of the second reception unit 12. The coherent transmission front end 120A is an example of the second transmission unit 17.

In the example of FIG. 6, the measurement unit 13 includes a selector 131, an A/D converter 132, a buffer memory 133, a demodulator 134, and a control unit 135. The control unit 135 controls the selector 131 and the demodulator 134.

The selector 131 outputs an optical signal of one wavelength selected from optical signals of respective wavelengths of the coherent reception front ends of the wavelength conversion units 2061 to 206N to the A/D converter 132 in accordance with an instruction from the control unit 135.

The buffer memory 133 temporarily records data of the optical signal digitalized by the A/D converter 132. The demodulator 134 performs error detection based on the data of each optical signal recorded in the buffer memory 133 and calculates the quality of each optical signal.

The first compensation unit 14 may determine the parameter for compensation of the first optical signal based on the parameter in a case where an error detection for measuring the quality of the first optical signal is performed by the demodulator 134 (measurement unit 13). In this case, the first compensation unit 14 may determine a parameter for compensation of the first optical signal by using a parameter obtained by analog compensation such as, for example, band compensation, PDL compensation (polarization dependency loss compensation), or dispersion compensation. In addition, the first compensation unit 14 may determine a parameter for compensation of the first optical signal by using a parameter obtained by a digital compensator such as, for example, skew compensation, wavelength dispersion compensation, or polarization dispersion compensation. Furthermore, the first compensation unit 14 may perform error correction and symbol mapping by using, for example, data (e.g., data for mapping in symbols and data for error detection) calculated by the demodulator 134.

Furthermore, the first compensation unit 14 may determine compensation processing related to the quality of the first optical signal measured by the demodulator 134 (measurement unit 13). In this case, the first compensation unit 14 may execute compensation of a higher degree the lower the quality calculated by the demodulator 134 (measurement unit 13). Each compensation processing may be a compensation processing in which the power consumption and the processing delay increase as the processing content is more complex the higher the degree of compensation. In this case, for example, in a case where the calculated quality is equal to or more than the first threshold value, the first compensation unit 14 may execute the first compensation processing. Furthermore, for example, in a case where the calculated quality is less than a first threshold value and equal to or more than a second threshold value lower than the first threshold value, the first compensation unit 14 may execute the second compensation processing. Furthermore, for example, in a case where the calculated quality is less than the second threshold value and equal to or more than a third threshold value lower than the second threshold value, the first compensation unit 14 may execute the third compensation processing. Furthermore, for example, in a case where the calculated quality is less than the third threshold value, the first compensation unit 14 may execute the fourth compensation processing. In this case, the first compensation processing may be, for example, waveform distortion compensation. In addition, the second compensation processing may be, for example, waveform distortion compensation and polarization separation (polarization dispersion) compensation. In addition, the third compensation processing may be, for example, waveform distortion compensation, polarization separation compensation, and carrier phase compensation. The fourth compensation processing may be, for example, waveform distortion compensation, polarization separation compensation, carrier phase compensation, and error detection and correction.

In addition, the first compensation unit 14 may compensate for the quality of the optical signal according to the signal characteristic between the input of the coherent reception front end 110 and the output of the coherent transmission front end 120. In this case, for example, the data indicating the signal characteristics may be set in advance in a storage device inside the wavelength conversion device 206.

### Example of Analog Compensation

The first compensation unit 14 may perform compensation (analog compensation) on the analog electric signal obtained by converting the optical signal between the input of the coherent reception front end 110 and the output of the coherent transmission front end 120. In this case, the first compensation unit 14 may have, for example, an analog compensator including at least one of skew compensation, spectrum compensation, and IQ imbalance compensation. In this case, the first compensation unit 14 may perform skew compensation using, for example, at least one of a phase shifter and an analog Finite Impulse Response (FIR) filter. In addition, the first compensation unit 14 may perform, for example, spectrum compensation using an analog FIR filter. Furthermore, the first compensation unit 14 may perform IQ imbalance compensation using, for example, an FIR/DRV amplifier.

### Example of Digital Compensation

The first compensation unit 14 may perform compensation (digital compensation) on the digital data obtained by converting the optical signal between the input of the coherent reception front end 110 and the output of the coherent transmission front end 120. In this case, the first compensation unit 14 may have, for example, a digital compensator for executing at least one of skew compensation, wavelength dispersion compensation, and polarization dispersion compensation. In this case, an A/D converter is provided between the coherent reception front end 110 and the selector 131 instead of the A/D converter 132 in FIG. 6.

### Configuration of Coherent Reception Front End 110 and Coherent Transmission Front End 120

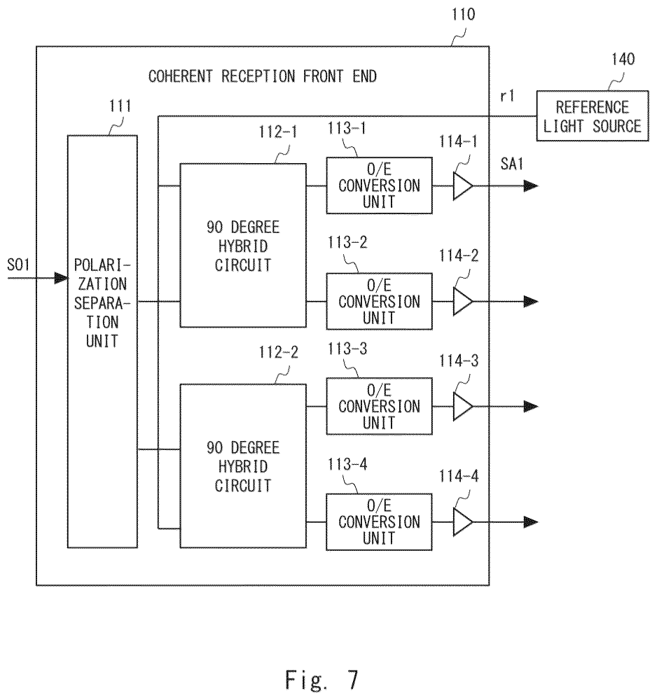

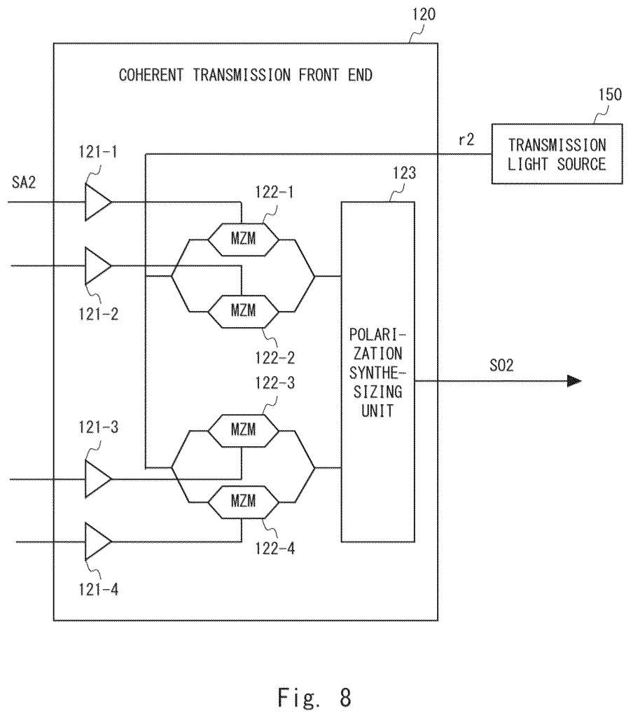

Next, configurations of the coherent reception front end 110 and the coherent transmission front end 120 according to the example embodiment will be described with reference to FIGS. 7 and 8. FIG. 7 is a diagram illustrating an example of a configuration of the coherent reception front end 110 according to the example embodiment. FIG. 8 is a diagram illustrating an example of a configuration of the coherent transmission front end 120 according to the example embodiment.

The coherent reception front end 110 converts an optical signal into an electric signal and performs coherent detection. The coherent reception front end 110 coherently detects the input optical signal SO1 to be input based on the local oscillation light r1 and outputs the generated analog electric signal SA1.

The coherent transmission front end 120 converts an electric signal into an optical signal and performs coherent modulation. The coherent transmission front end 120 coherently modulates the analog electric signal SA2 obtained by folding back the analog electric signal SAI based on the transmission light r2 and outputs the generated output optical signal SO2.

The input optical signal SO1 and the output optical signal SO2 are optical signals subjected to phase modulation and polarization multiplexing. The analog electric signals SA1 and SA2 are 4 lane (4 ch) signals including an XI signal of an I component (in-phase component) of the X polarized wave, an XQ signal of a Q component (quadrature component) of the X polarized wave, a YI signal of the I component of the Y polarized wave, and a YQ signal of the Q component of the Y polarized wave.

The frequency of the local oscillation light r1 is the frequency (carrier frequency) of the input optical signal SO1 to be received, and the frequency of the transmission light r2 is the frequency of the output optical signal SO2 to be transmitted. For example, the local oscillation light r1 and the transmission light r2 have different frequencies, but may have the same frequency. The wavelength of the optical signal to be folded back can be switched by changing the frequencies of the local oscillation light r1 and the transmission light r2. That is, the input optical signal SOI can be converted into the output optical signal

The wavelength conversion device 206 may include a reference light source 140 for generating the local oscillation light r1 and a transmission light source 150 for generating the transmission light r2. The reference light source 140 may be inside the coherent reception front end 110, and the transmission light source 150 may be inside the coherent transmission front end 120.

In the example of FIG. 7, the coherent reception front end 110 includes a polarization separation unit 111, 90 degree hybrid circuits 112-1 to 112-2, O/E conversion units 113-1 to 113-4, and amplifiers 114-1 to 114-4.

The polarization separation unit 111 polarization-separates the input optical signal SO1, that is the input polarization synthesized signal, into an X polarized wave and a Y polarized wave. The 90 degree hybrid circuits (coherent optical detectors) 112-1 to 112-2 perform coherent detection by interfering the optical signal polarization-separated by the polarization separation unit 111 with the local oscillation light r1 of the reference light source 140, and convert signals detected by the O/E conversion units 113-1 to 113-4 including a photo diode or the like into 4 lane analog electric signals. The 90 degree hybrid circuit 112-1 separates the X polarized wave of the input optical signal SO1 into an I component and a Q component, and then performs photoelectric conversion by the O/E conversion units 113-1 to 113-2 to generate an XI signal and an XQ signal. The 90 degree hybrid circuit 112-2 separates the Y polarized wave of the input optical signal SO1 into an I component and a Q component, and then performs photoelectric conversion by the O/E conversion units 113-3 to 113-4 to generate a YI signal and a YQ signal. The amplifiers 114-1 to 114-4 amplify the generated XI signal, XQ signal, YI signal, and YQ signal, respectively, and output the amplified signals to the first compensation unit 14 as 4 lane analog electric signals SA1. The first compensation unit 14 performs analog signal processing or digital signal processing on all or a part (X polarized wave or Y polarized wave) of the XI signal, the XQ signal, the YI signal, and the YQ signal.

In the example of FIG. 8, the coherent transmission front end 120 includes amplifiers 121-1 to 121-4, MZ modulators (MZM: Mach-Zehnder Modulators) 122-1 to 122-4, and a polarization synthesizing unit 123.

The amplifiers 121-1 to 121-4 amplify the XI signal, the XQ signal, the YI signal, and the YQ signal of the analog electric signal SA2 output directly or via the A/D converter from the first compensation unit 14, respectively, and drive the MZ modulators 122-1 to 122-4. The MZ modulators (IQ optical modulators) 122-1 to 122-4 apply IQ modulation to the transmission light r2 of the transmission light source 150 according to the applied XI signal, XQ signal, YI signal, and YQ signal, respectively. The MZ modulators 122-1 to 122-2 generate an IQ modulated optical signal of an X polarized wave based on the XI signal and the XQ signal via the amplifiers 121-1 to 121-2. The MZ modulators 122-3 to 122-4 generate an IQ modulated optical signal of a Y polarized wave based on the YI signal and the YQ signal via the amplifiers 121-3 to 121-4. The polarization synthesizing unit 123 polarization-synthesizes the generated IQ modulated optical signal of the X polarized wave and IQ modulated optical signal of the Y polarized wave, and outputs the synthesized optical signal as the output optical signal SO2.

### First Modified Example of Configuration of Wavelength Conversion Device 206

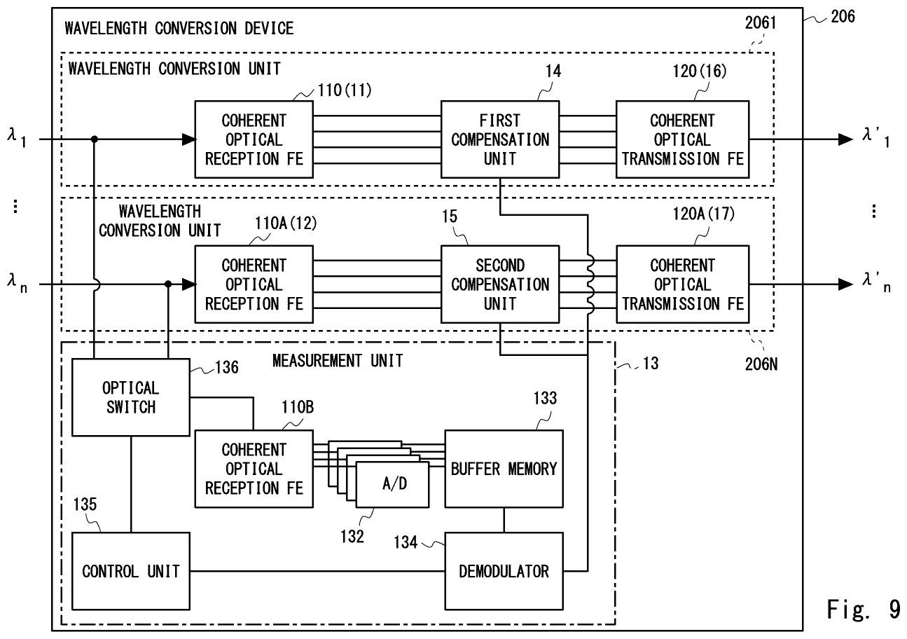

Next, another example of the configuration of the wavelength conversion device 206 according to the example embodiment will be described with reference to FIG. 9. FIG. 9 is a diagram illustrating an example of a configuration of the wavelength conversion device 206 according to the example embodiment. In the example of FIG. 6, an example in which an analog electric signal obtained by converting an optical signal or digital data obtained by converting an optical signal is input to the measurement unit 13 has been described.

In the example of FIG. 9, an example in which light of an optical signal is input to the measurement unit 13 will be described. As a result, for example, even if the type (analog compensator or digital compensator) of each compensation unit (e.g., the first compensation unit 14 and the second compensation unit 15) included in the wavelength conversion unit 2061 to 206N is different, implementation can be more easily performed.

In the example of FIG. 9, the same reference numerals are denoted to the same configurations as those of the example of FIG. 6, and redundant description will be omitted. Hereinafter, differences between the example of FIG. 9 and the example of FIG. 6 will be mainly described. The example of FIG. 9 is different from the example of FIG. 6 in that the measurement unit 13 includes an optical switch 136 and a coherent reception front end 110B instead of the selector 131.

The optical switch 136 outputs one or more optical signals selected from the optical signals input to each of the wavelength conversion units 2061 to 206N to the coherent reception front end 110B in accordance with an instruction from the control unit 135. The coherent reception front end 110B converts the input optical signal into an electric signal and outputs the electric signal to the A/D converter 132.

### Second Modified Example of Configuration of Wavelength Conversion Device 206

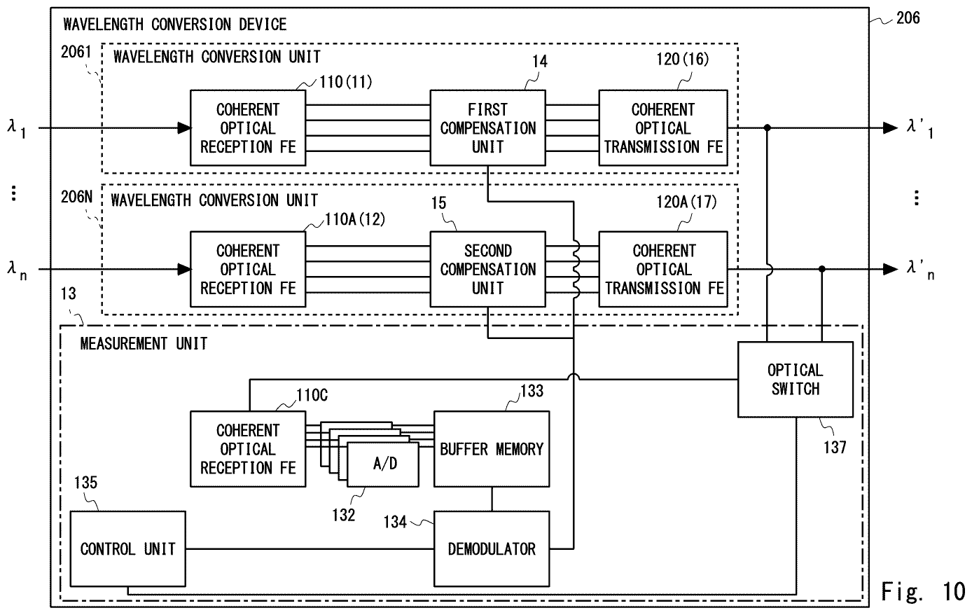

Next, another example of the configuration of the wavelength conversion device 206 according to the example embodiment will be described with reference to FIG. 10. FIG. 10 is a diagram illustrating an example of a configuration of the wavelength conversion device 206 according to the example embodiment. In the example of FIG. 9, an example in which light of one or more optical signals selected from the optical signals input to each of the wavelength conversion units 2061 to 206N is input to the measurement unit 13 has been described.

In the example of FIG. 10, an example in which light of one or more optical signals selected from the optical signals output from each of the wavelength conversion units 2061 to 206N is input to the measurement unit 13 will be described. As a result, for example, similarly to the example of FIG. 9, even if the type (analog compensator or digital compensator) of each compensation unit (e.g., the first compensation unit 14 and the second compensation unit 15) included in the wavelength conversion unit 2061 to 206N is different, implementation can be more easily performed.

In the example of FIG. 10, the same reference numerals are denoted to the same configurations as those of the example of FIG. 6, and redundant description will be omitted. Hereinafter, differences between the example of FIG. 10 and the example of FIG. 6 will be mainly described. The example of FIG. 10 is different from the example of FIG. 6 in that the measurement unit 13 includes an optical switch 137 and a coherent reception front end 110C instead of the selector 131.

The optical switch 137 outputs one or more optical signals selected from the optical signals output from each of the wavelength conversion units 2061 to 206N to the coherent reception front end 110C in accordance with an instruction from the control unit 135. The coherent reception front end 110C converts the input optical signal into an electric signal and outputs the electric signal to the A/D converter 132.

### Third Modified Example of Configuration of Wavelength Conversion Device 206

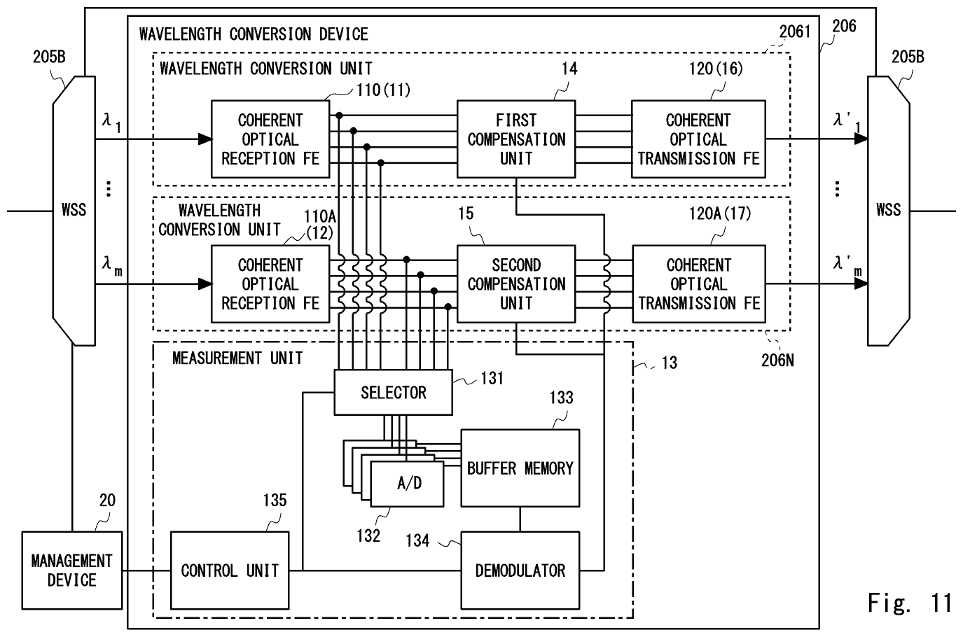

Next, another example of the configuration of the wavelength conversion device 206 according to the example embodiment will be described with reference to FIG. 11. FIG. 11 is a diagram illustrating an example of a configuration of the wavelength conversion device 206 according to the example embodiment.

In the example of FIG. 11, an example of switching the reception unit for receiving the optical signal based on the quality of the optical signal measured by the measurement unit 13 will be described. As a result, for example, in a case where the type (analog compensator or digital compensator) of each compensation unit (e.g., the first compensation unit 14 and the second compensation unit 15) included in the wavelength conversion units 2061 to 206N is different, a more appropriate compensator can be used.

In the example of FIG. 11, the same reference numerals are denoted to the same configurations as those of the example of FIG. 6, and redundant description will be omitted. Hereinafter, differences between the example of FIG. 11 and the example of FIG. 6 will be mainly described.

In the example of FIG. 11, the measurement unit 13 transmits information indicating the quality of each optical signal to the management device 20. Then, the management device 20 selects a wavelength conversion unit including a compensation unit suitable for compensation of the optical signal among the wavelength conversion units 2061 to 206N based on the quality of the optical signal measured by the measurement unit 13. In this case, the management device 20 may select a wavelength conversion unit including a compensation unit capable of performing compensation to a higher degree the lower the quality of the optical signal.

Then, for example, the management device 20 transmits a command indicating a wavelength conversion unit to be a transmission destination of the optical signal to the optical switch 205A. Then, the optical switch 205A switches the reception unit for receiving the optical signal from, for example, the first reception unit 11 to another vacant (e.g., not receiving an optical signal) reception unit (e.g., the second reception unit 12) in accordance with the received command.

### Hardware Configuration of Measurement Unit 13

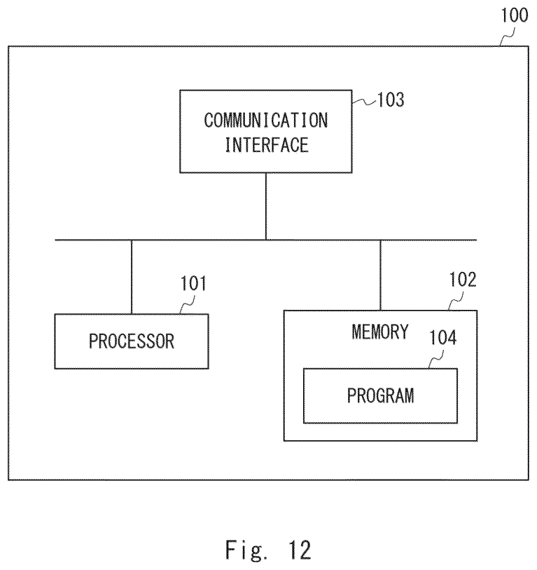

FIG. 12 is a diagram illustrating a hardware configuration example of a computer 100 of the measurement unit 13 (control unit 135) according to the example embodiment. In the example of FIG. 12, the computer 100 includes a processor 101, a memory 102, and a communication interface 103. These units may be connected by a bus or the like. The memory 102 stores at least a part of a program 104. The communication interface 103 includes an interface necessary for communication with other network elements.

Once the program 104 is executed by the cooperation of the processor 101, the memory 102, and the like, at least a part of processing according to the example embodiment of the present disclosure is performed by the computer 100. The memory 102 may be of any type suitable for a local technology network. The memory 102 may be a non-transitory computer-readable storage medium, as a non-limiting example. The memory 102 may also be implemented using any suitable data storage technique such as a semiconductor-based memory device, a magnetic memory device and system, an optical memory device and system, a fixed memory, or a removable memory. Although only one memory 102 is illustrated in the computer 100, there may be several physically different memory modules in the computer 100. The processor 101 may be of any type. The processor 101 may include one or more of a general purpose computer, a dedicated computer, a microprocessor, a Digital Signal Processor (DSP), and a processor based on a multi-core processor architecture as a non-limiting example. The computer 100 may have a plurality of processors, such as an application specific integrated circuit chip that is temporally dependent on a clock that synchronizes the main processor.

Example embodiments of the present disclosure may be implemented in hardware or dedicated circuitry, software, logic, or any combination thereof. Some aspects may be implemented in hardware, while other aspects may be implemented in firmware or software that may be executed by a controller, a microprocessor or other computing devices.

The present disclosure also provides at least one computer program product tangibly stored on a non-transitory computer-readable storage medium. The computer program product includes computer-executable instructions, such as those included in a program module, and is executed on a device on a target real or virtual processor to perform the processes or methods of the present disclosure. The program module includes routines, programs, libraries, objects, classes, components, data structures, and the like that execute particular tasks or implement particular abstract data types. Functions of the program module may be combined or divided between the program modules as desired in various example embodiments. A machine-executable instruction of the program module can be executed in a local or distributed device. In a distributed device, program modules can be located on both local and remote storage media.

Program code for executing the methods of the present disclosure may be written in any combination of one or more programming languages. These program codes are provided to a processor or controller of a general purpose computer, a dedicated computer, or other programmable data processing devices. Once the program code is executed by the processor or controller, the functions/operations in the flowcharts and/or the implemented block diagrams are performed. The program code is executed entirely on the machine, partly on the machine, as a stand-alone software package, partly on the machine, partly on a remote machine, or entirely on the remote machine or the server.

The program can be stored and supplied to the computer using various types of non-transitory computer-readable media. The non-transitory computer-readable medium includes various types of tangible recording media. Examples of the non-transitory computer-readable medium include a magnetic recording medium, a magneto-optical recording medium, an optical disc medium, and a semiconductor memory. Examples of the magnetic recording medium include a flexible disk, a magnetic tape, and a hard disk drive. Examples of the magneto-optical recording medium include a magneto-optical disk. Examples of the optical disc medium include a Blu-ray disc, a Compact disc (CD)-Read Only Memory (ROM), a CD-Recordable (R), and a CD-ReWritable (RW). Examples of the semiconductor memory include a solid state drive, a mask ROM, a Programmable ROM (PROM), an Erasable PROM (EPROM), a flash ROM, and a random access memory (RAM). The program may be supplied to the computer using various types of transitory computer-readable media. Examples of the transitory computer-readable media include electric signals, optical signals, and electromagnetic waves. The transitory computer-readable media can provide the program to the computer via a wired communication line such as an electric wire and optical fibers or a wireless communication line.

### Others

In an optical communication network such as a core/metro network that transmits large-capacity data, optical communication is connected among a plurality of ring networks by using a Wavelength Selective Switch (WSS). The WSS outputs an input Wavelength Division Multiplexing (WDM) signal to an output port that is different for each wavelength.

In a case where a plurality of nodes in the optical communication network are connected to each other, optical signals including the same wavelength cannot be transmitted by the same optical fiber. Therefore, the transmission is performed with the wavelength shifted in the optical relay device. In a case where a received optical signal having a certain wavelength is converted into a digital signal, error detection and correction, signal quality monitoring, and the like are performed, and then the digital signal is reconverted into an optical signal having a different wavelength and relayed, a problem arises in power consumption, processing delay, and the like.

Therefore, for example, a method (analog wavelength conversion method) of converting an optical signal having a certain wavelength into an optical signal having another wavelength without converting into a digital signal has been studied. In addition, a method (digital wavelength conversion method) of converting an optical signal having a certain wavelength into a digital signal and reconverting the digital signal into an optical signal having a different wavelength without performing digital signal processing such as error detection and correction has been studied. In these methods, power consumption and processing delay can be reduced as digital signal processing such as error detection and correction is not performed. However, in these methods, since the error detection is not performed, the signal quality cannot be monitored based on the error detection.

On the other hand, according to the present disclosure, for example, the quality of each optical signal is intermittently monitored, and hence error detection can be performed while reducing power consumption and processing delay. As a result, an optical signal can be appropriately transmitted.

### Modified Examples

The optical relay device 10 may be a device included in one housing, but the optical relay device 10 of the present disclosure is not limited thereto. The control unit 135 and the like of the optical relay device 10 may be achieved by, for example, cloud computing including one or more computers. In addition, the optical relay device 10 and the management device 20 may be configured as an integrated device. In addition, the management device 20 may execute processing of at least some of the functional units such as the control unit 135 of the optical relay device 10. Such an optical relay device 10 is also included in an example of the “optical relay device” of the present disclosure.

The present invention is not limited to the above example embodiments, and can be appropriately changed without departing from the scope.

Some or all of the example embodiments described above may be described as, but are not limited to, the following Supplementary Notes.

### Supplementary Note 1

An optical relay device including:
a first reception unit for receiving a first optical signal,
a second reception unit for receiving a second optical signal,
a measurement unit for sequentially measuring a quality of the first optical signal and a quality of the second optical signal,
a first compensation unit for compensating for the first optical signal based on the quality of the first optical signal measured by the measurement unit,
a second compensation unit for compensating for the second optical signal based on the quality of the second optical signal measured by the measurement unit,
a first transmission unit for transmitting the first optical signal subjected to wavelength conversion, and
a second transmission unit for transmitting the second optical signal subjected to wavelength conversion.

### Supplementary Note 2

The optical relay device according to supplementary note 1, in which the measurement unit determines a frequency of measuring quality of the first optical signal based on the measured quality of the first optical signal.

### Supplementary Note 3

The optical relay device according to supplementary note 2, in which the measurement unit measures the quality of the first optical signal at a first frequency in a case where the measured quality of the first optical signal is a first quality, and measures the quality of the first optical signal at a second frequency higher than the first frequency in a case where the measured quality of the first optical signal is a second quality lower than the first quality.

The optical relay device according to supplementary note 1, in which the measurement unit determines a frequency of measuring quality of the first optical signal based on an elapsed time of communication by the first optical signal.

### Supplementary Note 5

The optical relay device according to supplementary note 4, in which the measurement unit measures quality of the first optical signal at a third frequency in a case where an elapsed time of communication by the first optical signal is a first elapsed time, and measures quality of the first optical signal at a fourth frequency lower than the third frequency in a case where an elapsed time of communication by the first optical signal is a second elapsed time longer than the first elapsed time.

### Supplementary Note 6

The optical relay device according to supplementary note 1, in which the first compensation unit determines a parameter for compensation of the first optical signal based on a parameter in a case where an error detection for measuring quality is performed by the measurement unit.

### Supplementary Note 7

The optical relay device according to supplementary note 1, in which the first compensation unit determines compensation processing related to the quality of the first optical signal measured by the measurement unit.

### Supplementary Note 8

The optical relay device according to supplementary note 1, in which the first compensation unit includes an analog compensator including at least one of skew compensation, spectrum compensation, and IQ imbalance compensation.

### Supplementary Note 9

The optical relay device according to supplementary note 1, in which the first compensation unit includes a digital compensator for executing at least one of skew compensation, wavelength dispersion compensation, and polarization dispersion compensation.

### Supplementary Note 10

An optical communication system including an optical relay device and a management device, in which
the optical relay device includes:
a first reception unit for receiving a first optical signal,
a second reception unit for receiving a second optical signal,
a measurement unit for sequentially measuring a quality of the first optical signal and a quality of the second optical signal,
a first compensation unit for compensating for the first optical signal based on the quality of the first optical signal measured by the measurement unit,
a second compensation unit for compensating for the second optical signal based on the quality of the second optical signal measured by the measurement unit,
a first transmission unit for transmitting the first optical signal subjected to wavelength conversion, and
a second transmission unit for transmitting the second optical signal subjected to wavelength conversion, and
the management device switches a reception unit for receiving the first optical signal from the first reception unit to the second reception unit based on the quality of the first optical signal measured by the measurement unit.

### Supplementary Note 11

A wavelength conversion device including:
a first reception unit for receiving a first optical signal,
a second reception unit for receiving a second optical signal,
a measurement unit for sequentially measuring a quality of the first optical signal and a quality of the second optical signal,
a first compensation unit for compensating for the first optical signal based on the quality of the first optical signal measured by the measurement unit,
a second compensation unit for compensating for the second optical signal based on the quality of the second optical signal measured by the measurement unit,
a first transmission unit for transmitting the first optical signal subjected to wavelength conversion, and
a second transmission unit for transmitting the second optical signal subjected to wavelength conversion.

### Supplementary Note 12

An optical relay method including:
receiving a first optical signal by a first reception unit,
receiving a second optical signal by a second reception unit,
sequentially measuring a quality of the first optical signal and a quality of the second optical signal,
compensating for the first optical signal based on the measured quality of the first optical signal, and transmitting the first optical signal subjected to wavelength conversion, and
compensating for the second optical signal based on the measured quality of the second optical signal, and transmitting the second optical signal subjected to wavelength conversion.

### REFERENCE SIGNS LIST

1 optical communication system
10, 10A to G optical relay device
11 first reception unit
12 second reception unit
13 measurement unit
14 first compensation unit
15 second compensation unit
16 first transmission unit
17 second transmission unit
20 management device
131 selector
132 A/D converter
133 buffer memory
134 demodulator
135 control unit
136 optical switch
137 optical switch
206 wavelength conversion device
2061 to 206N wavelength conversion unit

What is claimed is:

1. An optical relay device comprising:
a first reception unit for receiving a first optical signal;
a second reception unit for receiving a second optical signal;
a measurement unit for sequentially measuring a quality of the first optical signal and a quality of the second optical signal;
a first compensation unit for compensating for the first optical signal based on the quality of the first optical signal measured by the measurement unit;
a second compensation unit for compensating for the second optical signal based on the quality of the second optical signal measured by the measurement unit;
a first transmission unit for transmitting the first optical signal subjected to wavelength conversion; and
a second transmission unit for transmitting the second optical signal subjected to wavelength conversion.

2. The optical relay device according to claim 1, wherein the measurement unit determines a frequency of measuring quality of the first optical signal based on the measured quality of the first optical signal.

3. The optical relay device according to claim 2, wherein the measurement unit measures the quality of the first optical signal at a first frequency in a case where the measured quality of the first optical signal is a first quality, and measures the quality of the first optical signal at a second frequency higher than the first frequency in a case where the measured quality of the first optical signal is a second quality lower than the first quality.

4. The optical relay device according to claim 1, wherein the measurement unit determines a frequency of measuring quality of the first optical signal based on an elapsed time of communication by the first optical signal.

5. The optical relay device according to claim 4, wherein the measurement unit measures quality of the first optical signal at a third frequency in a case where an elapsed time of communication by the first optical signal is a first elapsed time, and measures quality of the first optical signal at a fourth frequency lower than the third frequency in a case where an elapsed time of communication by the first optical signal is a second elapsed time longer than the first elapsed time.

6. The optical relay device according to claim 1, wherein the first compensation unit determines a parameter for compensation of the first optical signal based on a parameter in a case where an error detection for measuring quality is performed by the measurement unit.

7. The optical relay device according to claim 1, wherein the first compensation unit determines compensation processing related to the quality of the first optical signal measured by the measurement unit.

8. The optical relay device according to claim 1, wherein the first compensation unit includes an analog compensator including at least one of skew compensation, spectrum compensation, and IQ imbalance compensation.

9. The optical relay device according to claim 1, wherein the first compensation unit includes a digital compensator for executing at least one of skew compensation, wavelength dispersion compensation, and polarization dispersion compensation.

10. An optical communication system comprising an optical relay device and a management device, wherein
the optical relay device includes:
a first reception unit for receiving a first optical signal,
a second reception unit for receiving a second optical signal,
a measurement unit for sequentially measuring a quality of the first optical signal and a quality of the second optical signal,
a first compensation unit for compensating for the first optical signal based on the quality of the first optical signal measured by the measurement unit,
a second compensation unit for compensating for the second optical signal based on the quality of the second optical signal measured by the measurement unit,
a first transmission unit for transmitting the first optical signal subjected to wavelength conversion, and
a second transmission unit for transmitting the second optical signal subjected to wavelength conversion; and
the management device switches a reception unit for receiving the first optical signal from the first reception unit to the second reception unit based on the quality of the first optical signal measured by the measurement unit.

11. (Canceled)

12. An optical relay method comprising:
receiving a first optical signal by a first reception unit;
receiving a second optical signal by a second reception unit;
sequentially measuring a quality of the first optical signal and a quality of the second optical signal;
compensating for the first optical signal based on the measured quality of the first optical signal, and transmitting the first optical signal subjected to wavelength conversion; and
compensating for the second optical signal based on the measured quality of the second optical signal, and transmitting the second optical signal subjected to wavelength conversion.
